(19) United States
(12) Patent Application Publication
(10) Pub. No.: US 2010/0146385 A1
(43) Pub. Date: Jun. 10, 2010

(54) ELECTRONIC DOCUMENTS

(76) Inventor: Alexander Goulandris, London (GB)

Correspondence Address: Luce, Forward, Hamilton & Scripps LLP, 2050 Main Street, Suite 600, Irvine, CA, 92614, US

(21) Appl. No.: 12/593,573

(22) PCT Filed: Mar. 27, 2008
(86) PCT No.: PCT/GB08/01063

§ 371 Date: Jan. 29, 2010

(30) Foreign Application Priority Data
Mar. 28, 2007 (GB) 0706024.7

(51) Int. Cl. G06F 3/01; G06F 17/00; G06Q 99/00; G06Q 10/00

(52) U.S. Cl. 715/255; 715/751; 705/342

(57) ABSTRACT

A method of amending an electronic document in a distributed electronic document system, the electronic document being associated with a current holder (H) who has a right of control over the document and a first party, the method of amending the electronic document comprising the steps of: holder H raising an amendment request which details the amendments required to the electronic document; sending the amendment request from H to the first party via the electronic document system for approval; updating the electronic document with the amendments detailed in the amendment request if the first party approves the amendment request, and transmitting the updated electronic document to current holder H wherein the method further comprises maintaining the right of control over the electronic document with H until the first party approves the amendment request.

### TECHNICAL FIELD OF THE INVENTION

The present invention relates to improvements to electronic documents. In particular, the present invention provides a technical environment and system in which a user of the system can interact with electronic documents in a manner that is comparable to the equivalent paper documents.

### BACKGROUND TO THE INVENTION

Computers and computer systems are increasingly prevalent in everyday life and are used in a variety of different ways, from communication exchange to document control. The use of electronic systems has seen the movement from a paper based environment to an electronic based environment in a number of different scenarios, including both technical and business areas.

There are however certain technical problems surrounding the legal equivalence of electronic documents compared to their paper equivalents and there are also associated issues with the usability of electronic documents.

One environment that has been traditionally paper based is the shipping industry which uses paper-based Bills of Lading to handle the shipment of goods by a carrier (C) from a seller (S) to a buyer (B). A Bill of Lading typically has three functions, namely that:
1. It describes the shipment, i.e., it identifies the shipper, receiver, pick up point/port and delivery point/port and describes the goods, for example, the quantity and quality of the goods and any remarks by the ship's Captain about damage;
2. It outlines the terms of the contract of carriage;
3. It constitutes title of the goods, when the Bill of Lading is negotiable.

A negotiable Bill of Lading is typically drafted by either the carrier or the shipper/seller. These parties then typically send the draft to one another for review and approval, before the original Bill is issued by the carrier or his agent.

A Bill of Lading is a multipurpose document whose functionality makes it one of the most important shipping documents in the shipping industry. Such a document, however, is usually accompanied by a number of distinct trade documents which often incorporate similar and frequently overlapping information. Due to this overlap of information, carriers typically copy information from one paper document to another and this retyping of information can lead to multiple intra-document errors, which in turn results in delays, as processing of conflicting documents takes time.

In addition to the above problems, there are other larger problems arising from the very use of a paper Bill of Lading. Firstly, ships frequently complete their voyages before the original Bill of Lading has reached the place or port of destination and this delay in the arrival of the cargo documentation can place a carrier in a difficult position. Either the carrier is forced to refuse to hand over the goods and thereby incur storage costs or the carrier has to hand over the goods without a Bill of Lading (an event which nullifies his insurance policy). This second course of action can expose the carrier to legal claims from the genuine Bill of Lading holder, who may later appear and demand the goods.

Secondly, the industry tradition of utilizing unrecorded physical possession of a paper Bill of Lading to demonstrate the legal ownership of the underlying goods is fraught with fraud risks. Blank Bills of Lading can often be stolen relatively easily thereby allowing the content of a genuine bill copied.

Thirdly, existing fraud problems are exacerbated by the industry's attempts to solve the issue of delays using bills issued in triplicate (wherein three originals bills are issued and signed). The first original is sent to the shipper (the exporter). The second is sent straight to the shipper's bank, in order to speed up the processing of any documentary credit. The last original is kept by the ship's Captain to compare with the bill presented at the discharge port.

The above problems with paper based Bills of Lading means that efforts have been made to replace these paper documents with electronic systems. However, the potential for an electronic Bill of Lading to be easily reproduced has slowed the adoption of such systems and has led to systems that provide only partial solutions to the above problems.

Known prior art systems that attempt to deal with some of the above described issues have generally failed to address in any detail the functional requirements of users of electronic documents.

In particular the following functional requirements are desirable for any electronic document system:
(a) Amendment of the Electronic Document. One of the key features of a Bill of Lading (B/L) for participants in the commodity trading, trade finance and shipping industries is the ability to amend the B/L after it has been issued. Such amendments may, for example, relate to the description of the cargo on board the ship (if a mistake was made in the original B/L) or the name of the discharge port (if a new holder of the B/L determines that the cargo should be discharged at a different port to that appearing on the face of the B/L). More generally, the ability to amend an electronic document for use in an environment that requires documents to be changed as they pass between users is desirable.
(b) Transfer of Electronic Document (“Negotiability”)/Conversation to Paper Form. The most valuable function of a BIL is its ‘negotiability’. A negotiable B/L is transferable to different parties in succession by endorsement and delivery, which means that its possession enables the holder (the current owner of a B/L) to deal with the goods represented by the B/L before delivery. A negotiable B/L may therefore be sold en route by endorsing the back of the B/L and delivering it to the new holder. To the extent that a holder wants to sell the cargo to another user of an electronic document handling system, this endorsement and delivery is achieved electronically. However, users require the flexibility to sell the cargo to non-users as well and any system which does not provide them with this flexibility is bound to fail. Accordingly, an electronic solution needs to provide users with the ability to convert the electronic bill into a paper bill which will be acceptable to the relevant parties, e.g. within the commodity trading and trade finance industries.
(c) Finally, a common feature of current (paper) practice is the so-called ‘switched’ B/L. Traders in the commodities markets engage heavily in arbitrage, a practice in which they buy commodities from a supplier for a low price and sell the commodity to a buyer at a higher price, in trades where they have a unique knowledge of the requirements of the buyer and the seller. ‘Switched’ bills are used when a trader wants to protect the identity of the shipper to prevent his buyers from cutting him out of possible future transactions involving the same buyer/seller combination. For example:
   trader (T) buys goods from supplier (S);
   S loads the goods on board the carrier's (C) vessel and C issues a bill of lading identifying S as the shipper;
   S endorses the bill to T;
   T has sold the goods on to his buyer (B) and should endorse the bill to B to effect the transfer in title to the goods. However, if T endorses that bill directly to B, B will know the identity of T's supplier and may buy the goods directly from S in future;
   T therefore asks C to ‘switch’ the existing bill: this means that a new bill is issued, in which T is named as the Shipper instead of S.

This practice is, however, fraught with difficulties and risks (T is subject to ‘shipper’ liabilities which he would not customarily have, C could be accused of misleading future holders by stating that the shipper was T when in fact it was S, etc.). The inventor has therefore developed a system which obviates the need for ‘switched’ B/Ls.

One known electronic document system is described in GB 2348026, the “Bolero” system. With regard to the three areas of functionality discussed above the following points are noted:

(a) Amendment of Documents. In the Bolero system, the current holder of the electronic bill of lading (“eB/L”) is able to send a message to the carrier (the vessel owner who transports the goods and issues bills of lading), requesting an amendment to the eB/L. However, within the functionality of the Bolero system, immediately upon sending that instruction, the electronic bill is automatically suspended by the system, pending receipt of a message from the carrier granting or denying the request. There is no time limit within which a carrier has respond to the message and, until he does, the eB/L remains suspended. It is noted that the carrier has the option (unilaterally) to grant or deny the request. This system therefore has three significant limitations:
(i) It prevents the user requesting the amendment from dealing with the eB/L while the Carrier decides whether to grant or deny the request for amendment. In the paper world, the holder could request an amendment and, pending a decision by the carrier, hold onto the original paper B/L. Therefore, if a good opportunity arises to negotiate (sell) the B/L he can still do so without needing to contact the carrier (all he will need to do is inform the carrier that he no longer wants to amend the B/L, he does not even have to mention that he has endorsed it on to someone else). Only when the amendment request is granted in the paper world will the holder lose control, because he will have to send the original B/L to the carrier for amendment. Under Bolero, riot only does the request itself initiate a loss of control, but it also does so for an indefinite time, thereby preventing a user in the meantime from trading what is a very valuable commodity. Given the fast pace at which traders work and the sudden and unexpected changes in the price of commodities, such a loss of control is considered very problematic.
(ii) It does not require the consent of the Shipper (the party who initially owns and ships the goods): under a B/L, the shipper will always be liable under the B/L and, as such, any amendments to the B/L impact on the shipper directly. Despite this, the Bolero system does not require the consent of the shipper to any amendments to the B/L, exposing the shipper to significant risks.
(iii) If the amendment is granted, a new document is created and the chain of endorsements, which shows the previous holders/owners of the B/L, is applied to the new eB/L: applying the historic chain of endorsements to the new eB/L suggests to future holders that each of the previous holders has actually endorsed the document in its amended form, which is incorrect (the intermediate holders have not necessarily consented to the amendment). This could have significant consequences, for example, if the amendment request changes the origin or destination of the cargo and the new origin/destination is a country with which one of the previous holders is prevented from trading (trade embargoes, sanctions etc.).

(b) Conversion of electronic document to paper document. In the Bolero system, a holder is entitled to request that the carrier switches the eB/L into a paper document. The characteristics of the resulting paper B/L are, however, problematic for many traders in the industry. The Bolero paper B/L states on its face that it originated as an electronic document and, rather than recreating the chain of endorsements, a print out of the chain is attached to the paper B/L to evidence the historic transfers. This means that the Bolero paper bill looks nothing like a traditional paper B/L (which would bear original signatures, usually on the reverse, evidencing the chain of endorsements) and there is considerable risk that someone receiving such a Bolero paper bill will reject it on the grounds that it is not good tender (there are developed principles applied by banks and traders internationally as to what a paper B/L should ‘look like’, and if it does not satisfy these criteria, it is likely to be rejected for non-conformity). Accordingly, traders require an alternative method for converting an eB/L to paper which will produce a paper B/L which looks like a traditional paper B/L so that they can trade it outside the electronic world.

(c) Switched Bills. Neither the Bolero system nor any of its predecessors have sought to overcome the issues arising as a result of ‘switched’ bills in the past. Bolero classified a ‘switch’ as an amendment to the bill and a party requiring a ‘switched’ bill had to request an amendment of the eB/L using the procedure described above.

A further known system is the Applicant's ESS-Databridge™ system (WO2006/103428) which comprises a decentralised architecture in which Electronic Document Notaries (EDN), operate as trusted document authorities. The EDN's servers and systems are responsible for notarizing the validity and ownership of title documents and related transactions. The system therefore comprises a number of EDN networks, each of which comprises the EDN and its registered users. All parties in the EDN network are bound by a legal contract that equates digitally signed electronic transactions within the network to their paper world equivalents. A network of two or more EDNs that establish mutual trust can create an extended network, within which any registered user in the network can trade with any other registered user on the network even if they are not both registered users of the same EDN. The above mentioned legal contract document facilitates this extended network by ensuring a legally enforceable network chain whereby the users of each EDN are contractually bound to the same rules in another trusted EDN as they would be within their registration EDN. FIG. 1 shows an extended network 1 which comprises two EDN networks (3,5), each EDN network comprising three registered users (7/7′, 9/9′ and 11/11′) and a central EDN server (13/13′). The legal contract document ensures that there is a mutual trust relationship 15 between servers 13 and 13′.

FIG. 2 is an overview of an interaction between two registered users (e.g. 7 and 9′) of the system 1, the first user 7 being located in EDN network 3 and the second user 9′ being located in EDN network 5. It can be seen that a communication 17 originating from the second user 9′ is first sent to the EDN server 13′ in network 5 before being notarized and forwarded to EDN server 13 in network 3. The message is sent on by server 13 to user 7 so that an appropriate action can be taken. A return message 19 follows the above steps but in reverse.

The ESS-Databridge™ manages access and transaction security so that only duly authorized parties can request that an electronic bill of lading is, for example, amended or converted to paper. All such transactions performed on an electronic title document are notarized by the associated EDN and logged. Once a message has been created in the ESS-Databridge™, it may be modified only by sending message requests to the EDN entrusted with that document.

Although the ESS-Databridge™ provides a more convenient and flexible electronic document system compared to prior art systems the inventors have acknowledged that the system may be further enhanced in order to further address the functionality issues discussed above.

It is against the above background that the present invention has been devised.

### SUMMARY OF THE INVENTION

According to a first aspect the present invention provides a method of amending an electronic document in a distributed electronic document system, the electronic document being associated with a current holder (H) who has a right of control over the document and a first party, the method of amending the electronic document comprising the steps of: holder H raising an amendment request which details the amendments required to the electronic document; sending the amendment request from H to the first party via the electronic document system for approval; updating the electronic document with the amendments detailed in the amendment request if the first party approves the amendment request, and transmitting the updated electronic document to current holder H wherein the method further comprises maintaining the right of control over the electronic document with H until the first party approves the amendment request.

The first aspect of the present invention provides a method of amending an electronic document that addresses the above mentioned problems with known electronic document systems. In the present aspect of the invention an electronic document is associated with two parties, the current holder of the document (H) and another party, referred to as the first party above. It is noted that the first party may be the party who originally issued the electronic document or may be a party who needs to sign off on any amendments.

According to the method of the first aspect of the invention holder H prepares an amendment request which is then sent to the first party for approval. In the event that the first party approves the changes detailed in the amendment request the electronic document is updated and then sent back to the holder H. However, it is noted that pending the approval of the first party the right of control over the electronic document is maintained with holder H. This therefore allows H the freedom to deal with the electronic document while the first party considers the amendment request.

Conveniently, the step of updating the electronic document may comprise the first party issuing an updated electronic document containing the amendments detailed in the amendment request.

Conveniently, as part of the updating process the right of control may be transferred from the current holder H to the first party. It is noted that by delaying the transfer of the right of control until the updating step, holder H retains the right to deal with the electronic document for as long as possible.

Conveniently, the updated electronic document may be transmitted to the current holder H in the transmitting step by the electronic document system.

Preferably, when the updated electronic document is returned to the holder H the right of control is returned from the first party to the holder H.

Conveniently, an endorsement chain associated with the previous version of the electronic document may be appended to the updated electronic document when the updated electronic document is returned to holder H.

Conveniently, the amendment request raised by holder H may additionally notify all the intermediate holders (if any) of the electronic document of the requested amendments. In the event that intermediate holders of the electronic document are notified of the amendment request, then the updating and approval step may require the first party and all intermediate holders of the document to approve the amendments required to the electronic document. Conveniently, the method may comprise notifying the current holder H if any of the intermediate holders refuse the amendment request.

In the event that intermediate holders of the electronic document are notified and one or more of them object to the amendment request, the method may comprise the step of offering the current holder the option of maintaining the amendment request with the first party only.

Conveniently, if holder H retracts the amendment request then the method may comprise the step of notifying the first party that the amendment request has been cancelled.

The above method requires only the first party to approve the amendment request. In other embodiments of the present invention more than one party may be required to approve the amendment request before the electronic document is updated. For example, the electronic document system may comprise a second user, and the sending step of the first aspect of the invention may comprise sending the amendment request to the first party and the second party for approval and the updating step may comprise updating the electronic document if both the first and second parties approve the amendment request.

According to a second aspect the present invention provides a method of converting an electronic document in a distributed electronic document system to an equivalent paper document, the electronic document being associated with a current holder (H), a first party who issued the electronic document and an intermediate holder of the electronic document, the method comprising the steps of: the current holder H requesting the first party to convert the electronic document to an equivalent paper equivalent document; the first party issuing a paper version of the electronic document; sending the paper document to the intermediate holder of the electronic document for signature; sending the paper document signed by the intermediate holder to the current holder H; sending the paper document from the current holder H to the first party for signature by the first party; returning the paper document, signed by the first party and the intermediate holder to the current holder.

The method of the second aspect of the present invention provides a method of converting an electronic document into an equivalent paper document. The electronic paper document is associated with a current holder (H), was issued by a first party and was associated with at least one intermediate holder (e.g. the document was issued by the first party, was transferred to the intermediate holder and subsequently transferred to the current holder).

The method comprises the first party, on request from the current holder (H), to convert the electronic document into a paper equivalent. It is noted that the first party does not physically sign this paper copy of the document but sends it to the intermediate holder for signature. Once the intermediate holder has signed the paper document it is sent to the current holder for checking. If everything is in order it is returned to the first party who signs the document and then returns it to the current holder.

The method of the second aspect of the invention provides a mechanism for creating a paper document that is the equivalent to the electronic document. Since the first party does not initially sign the paper document then this avoids any potential problems if the paper document is sent to a third party in error.

In the event that there are a plurality of consecutive intermediate holders between the first party and the current holder such that there is an endorsement chain starting at the first party and ending at the current holder H, then conveniently the first sending step may comprise sending the paper document to the next intermediate holder in the chain and the second sending step may comprise sending the paper document from the last intermediate holder to H. Preferably in such a case the first sending step is repeated until the paper document reaches the last intermediate holder of the electronic document.

Preferably, the method further comprises locking the electronic document within the electronic document system as soon as the current holder H requests the first party to convert the electronic document to a paper document.

Preferably, the method further comprises the step of notifying the electronic document system as soon as the first party has signed the paper document.

Conveniently, the electronic document system may mark the electronic version of the document as having being converted to paper as soon as it receives notification that the first party has signed the paper document.

It will be appreciated that preferred and/or optional features of the system aspects of the invention may be provided in the method aspects of the invention also, either alone or in appropriate combinations

The present invention also extends to a computer program when embodied on a record medium/read-only memory/electrical carrier signal or stored in a computer memory, the computer program comprising program instructions for causing a computer to perform the process of the method of the first and second aspects of the present invention.

In the context of the Bill of Lading example described above in relation to the shipping environment, the first party may be the carrier of the goods and the second party may be the shipper. The carrier would usually issue the bill of lading and transport the goods and the shipper would represent the seller of the goods.

### BRIEF DESCRIPTION OF THE DRAWINGS

Preferred embodiments of present invention will now be described, by way of example only, with reference to the accompanying drawings in which:

FIG. 1 shows a known architecture for the exchange of electronic documents;

FIG. 2 shows how the architecture of FIG. 1 handles communications between registered users;

FIG. 3 is a flow chart showing how amendments may be made to an electronic document in accordance with an embodiment of the present invention;

FIG. 4 is a flow chart showing amendments may be made to an electronic document in accordance with a further embodiment of the present invention;

FIG. 5 is a flow chart showing an electronic document may be converted to a paper form in accordance with an embodiment of the present invention;

FIG. 6 is a representation of an identifier address format for the location of electronic documents;

FIG. 7 is a flow chart showing how the identity of a holder of an electronic document may be masked by holders later in the ownership chain in accordance with an embodiment of the present invention;

FIG. 8 is a schematic of an electronic document system in accordance with an embodiment of the present invention.

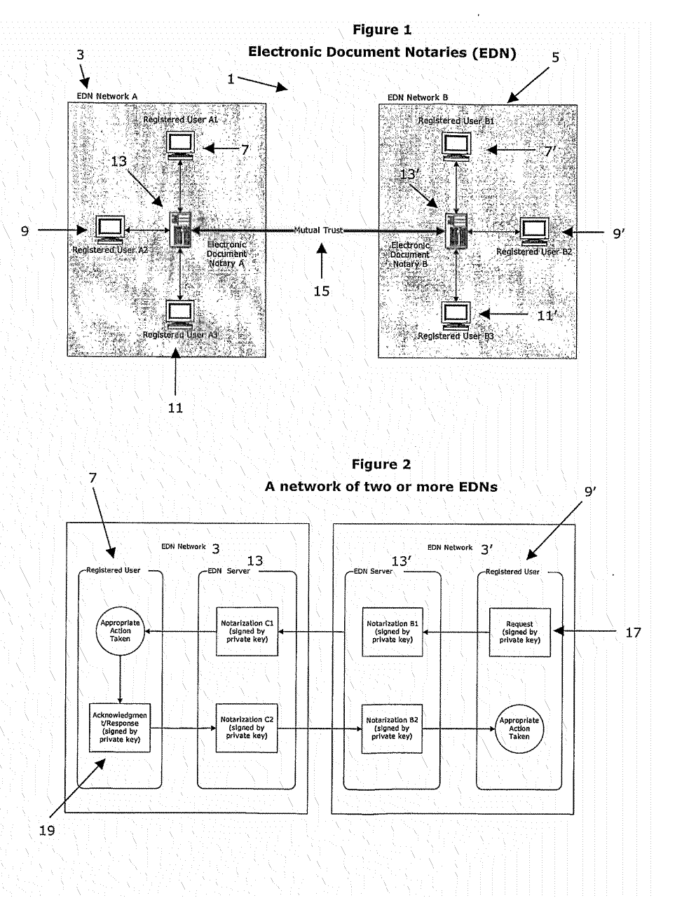

### DETAILED DESCRIPTION OF THE INVENTION

In the following description and associated drawings, like numerals are used to denote like features.

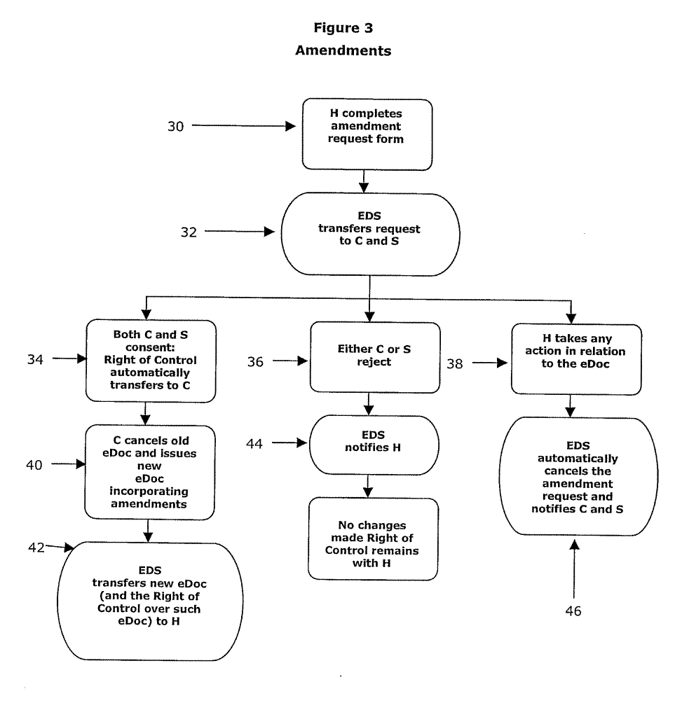

FIG. 3 illustrates a procedure for amending an electronic document (eDoc) within an electronic document system (EDS) in accordance with an embodiment of the present invention.

It is noted that the example below is presented in the context of a Bill of Lading and the shipping environment but is equally applicable to any electronic document exchange wherein a current holder (H) of the electronic document requires other users of the electronic document system to approve any amendments to the document. For example, an electronic document that is originally co-authored by two different users and then subsequently assigned to a further user (the current holder H) may require H to obtain authorisation from both co-authors in order to make amendments to the document.

It is also noted that although two other users (C and S) are discussed in relation to the example of FIG. 3, there may only be one other user that H requires authorisation from or potentially greater than two users.

Turning to FIG. 3, in step 30, current holder (H) of the electronic document completes an amendment request form which identifies those aspects of the electronic document that he wishes to amend and which further identifies which other users of the electronic document system he wishes to obtain consent from or whom he wishes to notify. It is noted that in the present example, H is required to obtain the consent of a carrier (C) and a shipper (S). It is further noted that the electronic document was originally issued by the carrier C and that the electronic document relates to goods that have been supplied by S and are being transported by C.

In Step 32, the electronic document system transfers the amendment request from H to C and S.

There are then three possible outcomes: (i) both C and S consent to the amendment request (Step 34); (ii) one or both of C and S reject the amendment request (Step 36); (iii) H takes some other action in relation to the electronic document (Step 38).

It is noted that pending a response from C and S regarding the amendment request, H retains the right of control over the electronic document and can, for example, endorse it to any other user or ask it to be converted to paper. If H does take any further action in this way then this automatically cancels the amendment request.

Returning to outcome 1 above, in Step 34, if both C and S consent to the amendment request then the electronic document system automatically transfers control of the electronic document from H to the carrier C for amendment.

In Step 40, C then cancels the old electronic document and issues a new electronic document which incorporates the amendments requested by H.

In Step 42, C then transfers the new electronic document back to H. It is noted that the right of control over the electronic document also passes from C to H.

Turning now to outcome 2, if either of C or S reject the amendment request (in Step 36) then a notification message is sent, in Step 44, by the electronic documents system to H. It is noted that in such a circumstance the right of control over the document will have remained with H thereby allowing H to deal with the electronic document as necessary.

Turing now to outcome 3, if H decides to take some other course of action with respect to the electronic document (Step 38) then the system will note this new course of action and in Step 46 will automatically cancel the amendment request. C and S will be sent a notification message informing them the amendment request has been cancelled.

In an alternative embodiment to FIG. 3, H may exercise the option, when completing the amendment request form, to seek the consent of all intermediate holders of the electronic document in addition to the consent of C and S.

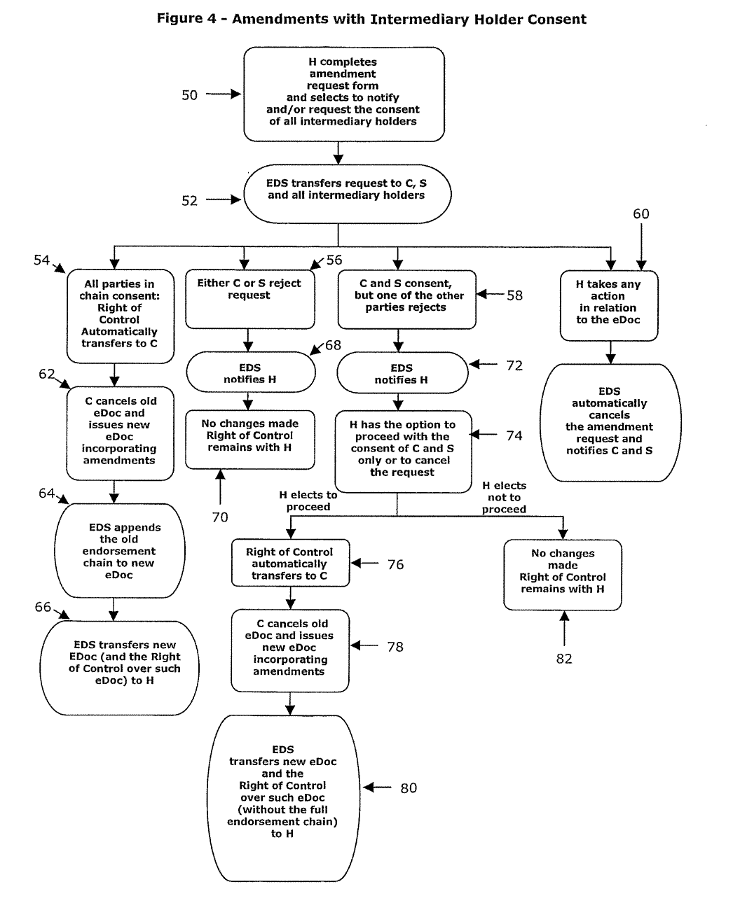

This option is illustrated in FIG. 4. It is noted that if H exercises this option then the electronic document system sends the amendment request to all intermediary holders of the electronic document with a request that they consent to the amendment. Assuming each holder consents to the amendment, then when C issues a new electronic document, the electronic document system can append to the new document an endorsement chain that mirrors the endorsement chain on the old (cancelled) version of the document.

Turning now to FIG. 4, in Step 50, H completes an amendment request form and selects to notify and/or request the consent of all intermediary holders of the electronic document that he currently has the right of control over.

In Step 52, the electronic document system sends the amendment request to C and S and all the intermediary holders.

There are now four possible outcomes: (i) all parties agree to the amendment request (Step 54); (ii) C or S reject the amendment request (Step 56); (iii) C and S consent to the amendment request but an intermediary party rejects the request (Step 58); (iv) H takes some other course of action (Step 60).

Returning to outcome 1, in Step 54, all parties in the control chain of the electronic document consent to the amendment requested by H and the electronic document system automatically transfers the right of control to C.

In Step 62, C cancels the old electronic document and issues a new electronic document which comprises the requested amendments.

In Step 64, the electronic document system then appends the old endorsement chain to the new electronic document and, in Step 66, transfers the new electronic document to H. Control over the document is also handed back to H in Step 66.

Turning to outcome 2, the amendment request is rejected in Step 56 by either (or both) of C and/or S. In Step 68, the electronic documents system notifies H that the request has been rejected. Since no changes have been made to the document the right of control remains with H (Step 70).

Turning to outcome 3, in Step 58 C and S have indicated their consent to the amendment request but one of the intermediary parties has rejected the request.

In Step 72 the electronic documents system notifies H of the rejection.

In Step 74, H is given the option of proceeding on the basis of the consent of C and S only or cancelling the amendment request.

In Step 76, H has elected to proceed and the right of control automatically is transferred to C.

In Step 78, C cancels the old electronic document and issues a new electronic document which incorporates all the amendments requested by H.

In Step 80, the electronic document system transfers the new electronic document (and right of control) to H. It is noted that in this case the full endorsement chain is not appended to the document.

If, however, H decides in Step 74 not to proceed with the amendment request then at Step 82, no changes are made to either the electronic document or the right of control over the document (which remains with H) and the process ends.

Turning to outcome 4, if, in Step 60, H decides to take alternative action with respect to the electronic document then, in Step 84 the electronic documents system automatically cancels the amendment request and notifies C and S.

It is noted that the amendment request procedure discussed above with relation to FIGS. 3 and 4 combines technological processes with a suitable legal framework which thereby enables a user to interact with an electronic document in the same manner and with the same results as in the paper world.

As discussed above another problem with known electronic document solutions is the manner in which they handle the conversion of electronic documents to paper equivalent documents.

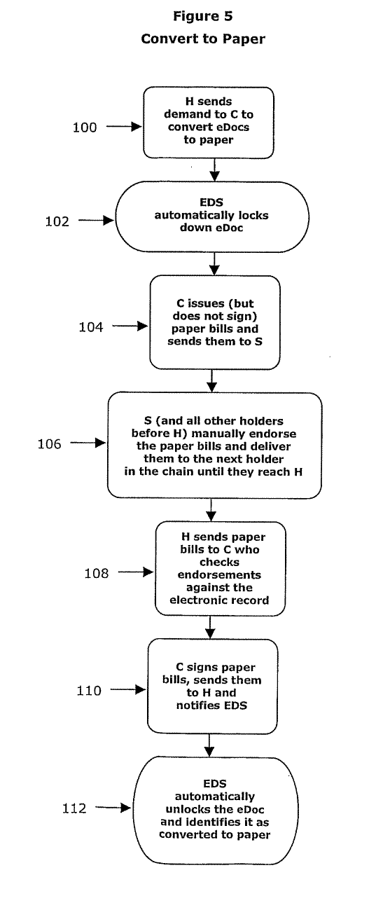

FIG. 5 is a flow chart of a process in accordance with an embodiment of the present invention that allows an electronic document to be effectively converted to a paper form to enable a user to effectively interact with persons outside of the electronic document system. Again, the example below is presented in the context of a Bill of Lading and the shipping environment but is equally applicable to any electronic document exchange wherein a user of the electronic document system needs to interact with persons outside of the electronic document system.

In Step 100, the current holder H of an electronic document (electronic bill) demands that the carrier C (i.e. the issuer of the electronic document) converts the document into paper form.

In Step 102, the electronic document system locks down the electronic document in question to prevent users from taking any action with respect to that document. The rationale behind this process is that the electronic document is effectively frozen and a paper document (paper bill) will be created which then “catches up” the electronic version of the document.

In Step 104, C issues a paper version of the electronic document via a print function within the electronic document system. It is noted that C does not physically sign this paper copy of the document because if C signs the paper form and then delivers it to a third party then an intermediate party may incorrectly endorse the document and deliver the paper document to the wrong party (W). Once C signs the paper form of the bill this creates a valid contract which may grant rights and impose obligations on C and possibly any other holder of the document. Any wrongful transfer could therefore expose C to liability to W (under the paper form of the document) and to H (under the electronic form of the document). This is therefore the reason why C does not sign the paper form of the document at this time.

In Step 106, C delivers the paper document to the shipper of the goods who then endorses the paper document and sends it to the next holder in the chain.

The process of Step 106 is then repeated for each subsequent holder in the chain until the paper form of the document reaches H.

At Step 108, H checks the document and sends it to C for signature.

In Step 110, C checks that the endorsements on the paper document matches those on the (frozen) electronic document. Assuming that there is a match, C signs the paper form of the document and then delivers it to H.

At Step 112, C notifies the electronic document system that it has signed the paper document and the electronic document is then unlocked by the system which marks it as “converted to paper”.

The above process provides H with a true replica of his electronic document and additionally protects the document issuer (carrier C) from the risks associated with two bills (electronic and paper) in existence at the same time.

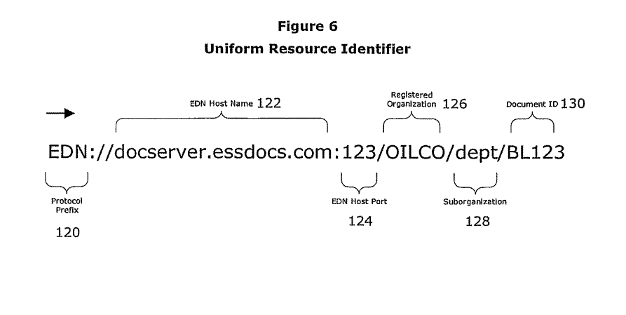

The security of the paper form of an electronic document is improved by the embodiments of the present invention. Once issued in paper form, there is significant potential for fraud, aggravated by the fact that there is no way in which a party presented with the paper document can check its contents against the electronic version to ensure that changes have not been made. The present invention therefore additionally provides a system for locating and retrieving the electronic document, which is accessible to anyone who knows the specialized Uniform Resource Identifier (URI). A document URI contains several parts (see FIG. 6): the Electronic Document Scheme Prefix 120, the Electronic Document Notary Host Name 122, the Electronic Document Notary Host Port (Optional) 124, the Registered User/Organization code 126, the Organizational subdivisions (Optional) 128 and a Document Number 130.

The URI may be printed on all paper documents. Anyone presented with such a paper document will be able to search the carrier's website, using the URI, for an electronic copy of the paper document, enabling them to check the terms of their paper bill against those of the electronic bill as it existed at the time of conversion to paper. This provides recipients of the paper document with an added layer of comfort and will therefore encourage the adoption and acceptance of electronic documents.

Electronic document systems, such as the ESS-Databridge™ may already mask the endorsement chain, preventing future holders from knowing the identity of previous holders of the electronic document.

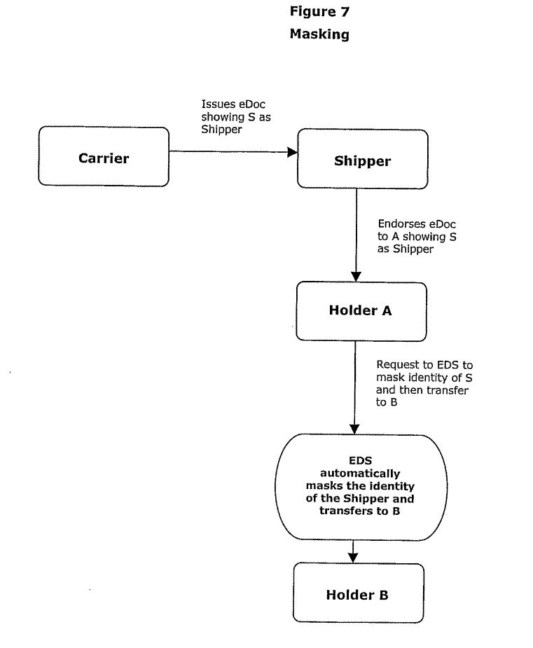

The uses to which this masking can be put have now been further refined in accordance with embodiments of the present invention, so that masking can be extended to the identity of the Shipper, obviating the need for ‘switched’ electronic documents. This process is shown in FIG. 7. In essence, the electronic document can be encrypted by the electronic document system following a request from a holder (Holder A) thereby concealing the identity of the Shipper. The encrypted document can be securely transmitted from the sender to the recipient.

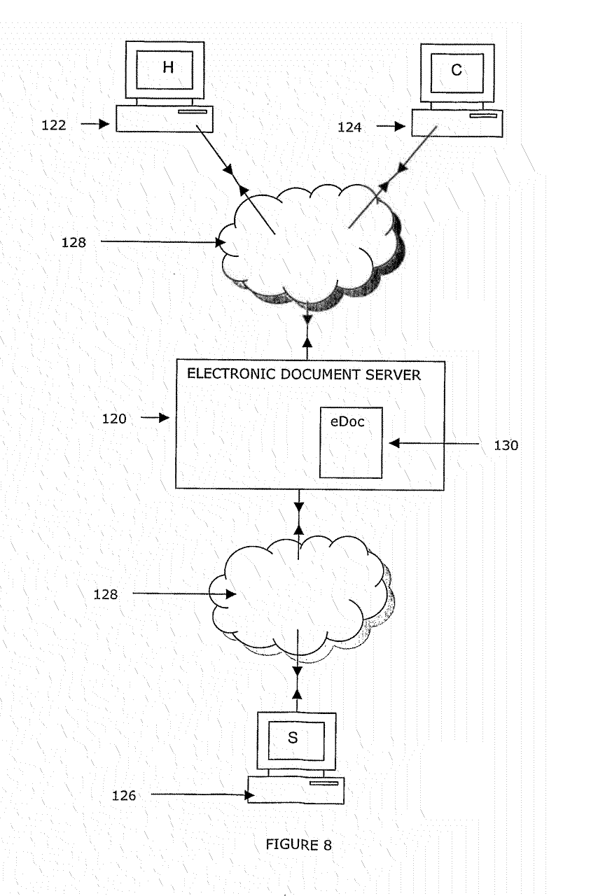

An example of a distributed electronic document system in accordance with embodiments of the present invention is shown in FIG. 8. The figure shows an electronic document system server 120 and a number of user terminals 122, 124, 126 which are in communication with the server 120 via a communications network 128 (e.g. the Internet). An electronic document 130 is stored on the server 120.

As depicted in FIG. 8, terminal 122 is the user terminal of the current holder H of the electronic document. Terminal 124 is associated with party C, the carrier and original issuing authority for the document 130. A shipper of goods associated with the electronic document is associated with terminal 126.

It is noted that the term current holder of the electronic document refers to the legal owner of the document rather than necessarily the physical location of the electronic document.

It will be understood that the embodiments described above are given by way of example only and are not intended to limit the invention, the scope of which is defined in the appended claims. It will also be understood that the embodiments described may be used individually or in combination.

1. A method of amending an electronic document in a distributed electronic document system, the electronic document being associated with a current holder (H) who has a right of control over the document and a first party, the method of amending the electronic document comprising:
holder H raising an amendment request which details the amendments required to the electronic document;
sending the amendment request from H to the first party via the electronic document system for approval;
updating the electronic document with the amendments detailed in the amendment request if the first party approves the amendment request, and
transmitting the updated electronic document to current holder H;
wherein the method further comprises maintaining the right of control over the electronic document with H until the first party approves the amendment request.

2. A method as claimed in claim 1, wherein the updating comprises the first party issuing an updated electronic document containing the amendments detailed in the amendment request.

3. A method as claimed in claim 1, wherein the updating comprises transferring the right of control over the electronic document from H to the first party.

4. A method as claimed in claim 1, wherein the updated electronic document is transmitted to the current holder H by the electronic document system.

5. A method as claimed in claim 3, wherein the transmitting comprises returning the right of control over the electronic document to H.

6. A method as claimed in claim 1, wherein the transmitting comprises the electronic document system appending an endorsement chain associated with the previous version of the electronic document to the updated electronic document.

7. A method as claimed in claim 1, wherein the raising the amendment request further comprises notifying all intermediate holders of the electronic document of the amendment request.

8. A method as claimed in claim 7, wherein the updating comprises updating the electronic document if the first party and all intermediate holders of the electronic document approve the amendment request.

9. A method as claimed in claim 7, further comprising notifying the current holder H if any of the intermediate holders refuse the amendment request.

10. A method as claimed in claim 7, further comprising offering the current holder the option of maintaining the amendment request with the first party only in the event that one or more intermediate holders refuse the amendment request.

11. A method as claimed in claim 1, further comprising notifying the first party that the amendment request has been cancelled in the event that H retracts the amendment request.

12. A method as claimed in claim 1, wherein the first party is the party who issued the electronic document.

13. A method as claimed in claim 1, wherein the electronic document system comprises a second user, and the sending comprises sending the amendment request to the first party and the second party for approval and updating comprises updating the electronic document if both the first and second parties approve the amendment request.

14. A method of converting an electronic document in a distributed electronic document system to an equivalent paper document, the electronic document being associated with a current holder (H), a first party who issued the electronic document and an intermediate holder of the electronic document, the method comprising:
the current holder H requesting the first party to convert the electronic document to an equivalent paper equivalent document;
the first party issuing a paper version of the electronic document;
sending the paper document to the intermediate holder of the electronic document for signature;
sending the paper document signed by the intermediate holder to the current holder H;
sending the paper document from the current holder H to the first party for signature by the first party; and
returning the paper document, signed by the first party and the intermediate holder to the current holder.

15. A method as claimed in claim 14, wherein there are a plurality of consecutive intermediate holders between the first party and the current holder such that there is an endorsement chain starting at the first party and ending at the current holder H and sending comprises sending the paper document to the next intermediate holder in the chain and updating comprises sending the paper document from the last intermediate holder to H.

16. A method as claimed in claim 15, wherein the sending is repeated until the paper document reaches the last intermediate holder of the electronic document.

17. A method as claimed in claim 14, further comprising locking the electronic document within the electronic document system as soon as the current holder H requests the first party to convert the electronic document to a paper document.

18. A method as claimed in claim 14, further comprising the step of notifying the electronic document system as soon as the first party has signed the paper document

19. A method as claimed in claim 18, wherein the electronic document system marks the electronic version of the document as having being converted to paper as soon as it receives notification that the first party has signed the paper document.

20. A computer record medium/read-only medium having instructions stored thereon for execution by a computer, the instructions comprising:
amending an electronic document in a distributed electronic document system, the electronic document being associated with a current holder (H) who has a right of control over the document and a first party, comprising:
holder H raising an amendment request which details the amendments required to the electronic document;
sending the amendment request from H to the first party via the electronic document system for approval;
updating the electronic document with the amendments detailed in the amendment request if the first party approves the amendment request; and
transmitting the updated electronic document to current holder H;
wherein the method further comprises maintaining the right of control over the electronic document with H until the first party approves the amendment request.

21. A computer record medium/read-only medium having instructions stored thereon for execution by a computer, the instructions comprising:
converting an electronic document in a distributed electronic document system to an equivalent paper document, the electronic document being associated with a current holder (H), a first party who issued the electronic document, and an intermediate holder of the electronic document, comprising:
the current holder H requesting the first party to convert the electronic document to an equivalent paper equivalent document;
the first party issuing a paper version of the electronic document;
sending the paper document to the intermediate holder of the electronic document for signature;
sending the paper document signed by the intermediate holder to the current holder H;
sending the paper document from the current holder H to the first party for signature by the first party; and
returning the paper document, signed by the first party and the intermediate holder to the current holder.

22. A method of amending an electronic document in a distributed electronic document system comprising an electronic document system server connected to a plurality of user terminals in a communications network, the electronic document being stored on the electronic document system server and associated with a current holder (H) located at a current holder user terminal who has a right of control over the document and a first party located at a first party user terminal, the method of amending the electronic document comprising:
holder H raising an amendment request which details the amendments required to the electronic document;
sending the amendment request from H to the first party via the electronic document system for approval;
updating the electronic document with the amendments detailed in the amendment request if the first party approves the amendment request, and
transmitting the updated electronic document to current holder H;
wherein the method further comprises maintaining the right of control over the electronic document with H until the first party approves the amendment request.
